(19) United States
(12) Patent Application Publication
(10) Pub. No.: US 2008/0140963 A1
(43) Pub. Date: Jun. 12, 2008

(54) METHODS AND SYSTEMS FOR STORAGE SYSTEM GENERATION AND USE OF DIFFERENTIAL BLOCK LISTS USING COPY-ON-WRITE SNAPSHOTS

(76) Inventors: Ronald G. Thomason, Andover, KS (US); William A. Hetrick, Wichita, KS (US)

Correspondence Address: LSI CORPORATION, 1621 BARBER LANE, MS: D-106, MILPITAS, CA, 95035, US

(21) Appl. No.: 11/608,931

(22) Filed: Dec. 11, 2006

(51) Int. Cl. G06F 12/00

(52) U.S. Cl. 711/162; 711/E12.001

(57) ABSTRACT

Methods and systems for generating differential backup or roll forward data within a storage system. Snapshot copies are generated within the storage system using copy-on-write techniques to maintain the integrity of the snapshots so generated. As an atomic operation with the generation of any snapshot, a copy of the list of data saved by the copy-on-write operations in any earlier snapshots is retained with the newly generated snapshot. The saved overwritten data list and any pair of corresponding snapshots may then be used to generate an accurate differential block list for data to be included in a differential backup or in a roll forward operation. Thus a storage system may generate differential backups or roll forward updates by its own processing to relieve attached host systems from the processing burden.

### BACKGROUND OF THE INVENTION

1. Field of the Invention

The invention relates generally to differential block lists of data in storage systems and more specifically relates to methods and systems for generating a differential backup or differential roll forward within a storage system using copy-on-write snapshots generated within the storage system.

2. Discussion of Related Art

In the data storage arts it is long recognized that backup of persistently stored data is required to assure integrity and reliability of the stored data. Typically, individual computing users or a computing enterprise periodically generate a backup copy of critical data required for continued functioning by the user or enterprise in case of data loss due to environmental conditions, operator errors, or any other reason.

It is generally known in the storage arts to utilize any of the three common types of backups. A “full backup” process generates a complete copy of all data in a base volume. The copied backup data may be persistently stored on another storage device (e.g., a backup storage device) so that it may be recovered in case of failure of the storage device/devices utilized to store the base volume data. Generating a full backup copy can be a time and storage space consuming process. Every data block, stripe, or cluster of blocks or stripes in the base of volume must be read from the base volume and written to an identified backup storage device. A full backup is restored to the base volume by simply reading all data on the backup storage device and writing it over any data on the base volume thus restoring the base volume to its status at the time of the full backup.

To reduce the time and space required for such backup procedures, “incremental backup” procedures are often preferred in the storage arts to reduce the space required and time required to generate the next backup. In an incremental backup, all the data on the base volume that has changed since the next previous backup procedure is retrieved and stored on the backup storage device (whether the previous procedure is a full backup or an earlier incremental backup). An incremental backup is computationally fast as compared to a full backup because far less data changes incrementally over time in most computing enterprises and thus far less data needed be read from the base volume and written to the backup storage device.

However, the process of restoring information from an incremental backup can be time and resource intensive. In particular, a full restoration of a volume using incremental backups requires first restoring the most recent full backup and then sequentially applying each and every incremental backup up to the most recent such incremental backup information. The restoration procedure cannot accurately proceed if, for example, any one or more of the intermediate incremental backup sets is unavailable or corrupted.

By contrast, a “differential backup” procedure backs up only data that has changed since the last full backup procedure. Differential backup processes are therefore generally faster than a full backup procedure but may be slower than an incremental backup procedure. However, by contrast with an incremental backup restoration, restoration of a differential backup requires access only to the most recent full backup set and the particular selected differential backup set corresponding to the point in time to which the user wishes to restore the base volume.

It has been long known in the storage arts to provide all three such backup procedures as functions within a computing node or server application. An administrator or other user commences a backup program or process and indicates whether the desired backup should be a full backup, an incremental backup, or a differential backup. The computing node then reads any required data from the base volume and writes the retrieved data to a selected backup storage device.

Such backup processing on host computing nodes or servers can be extremely time and resource consuming for the computing node. Hence, it is also known in the storage arts to provide some backup processing capabilities localized within the storage system per se. For example, a storage controller associated with the storage system may simply be given a directive from an attached host application requesting that the storage controller of the storage system initiates an identified backup process strictly using computational resources of the local processing power and memory of the storage controller within the storage system. For example, it is known in the storage art to provide full backup of a base volume in a storage system by requesting the storage controller of the storage system to generate a so-called snapshot volume copy. Such a snapshot copy is rapidly generated as a list of blocks of data of the identified volume that have changed since some earlier point in time. With such a list quickly established, the content of the identified changed blocks may be saved. Any changes to the earlier volume content following the creation of the snapshot copy may be processed by first saving any old content of the volume to the snapshot storage area and only then updating the data blocks in the volume. Processing within the storage controller establishes storage space for the requested snapshot and enables use of so-called copy-on-write operations for processing subsequent I/O write requests on the base volume. Copy-on-write operations save any current (old) data from the base volume to the snapshot copy prior to overwriting the identified data in the base volume. The saved older data is saved in the storage space associated with the identified snapshot copy. Thus, the first time old data from the base volume is overwritten, the current (old) data about to be overwritten in the base volume is first saved in the snapshot copy. Multiple such snapshot copies may be requested and stored by operation of the storage controller within the storage system. Each such snapshot copy is appropriately updated by subsequent copy-on-write operations performed responsive to further host I/O write requests. Thus a snapshot copy of a volume represents the content of the underlying volume saved at the earlier time of the creation of the snapshot—i.e., a compact representation of a full backup of the volume from the time of the snapshot. A full backup may then be created by retrieving blocks from the snapshot copy storage area for those blocks in the volume that have been changed and from the underlying volume for those blocks that have not changed since the time of the snapshot copy.

Snapshot copy processing, copy-on-write processing, and associated processing is well known to those of ordinary skill and the art as exemplified by commercial products such as the Microsoft volume shadow copy service—a standard feature in the Microsoft Windows Server family of products. Or, for example, Veritas storage management applications provide similar features also in a host based environment. It is also well known that such volume shadow copy and copy-on-write operations may be performed by processing generally localized within the storage system through its embedded storage controller.

Although volume snapshot copying and copy-on-write operations performed within the storage system through its storage controller are useful for generating full volume backups, incremental and differential backups are not generally performed by processing within the storage system by the embedded storage controller. Rather, in particular, as presently practiced, differential backup processing has been the exclusive domain of host based or server based backup application processes.

It is evident from the above discussion that a need exists for improved methods and systems for performing differential backup processing within a storage system.

### SUMMARY OF THE INVENTION

The present invention solves the above and other problems, thereby advancing the state of the useful arts, by providing methods and systems for generating differential block list data within a storage system. Snapshot copies are generated within the storage system using copy-on-write techniques to maintain the integrity of the snapshots so generated. As an atomic operation with the generation of any snapshot, a copy of the list of data saved by the copy-on-write operations in any earlier snapshots is retained with the newly generated snapshot. The saved overwritten data and the associated pair of corresponding snapshots may then be used to generate an accurate differential block list for data to be included in a differential backup. Thus a storage system may generate differential backups by its own processing to relieve attached host systems from the processing burden. In addition, features and aspects hereof may use the same differential block list to create a “roll forward” volume—i.e., a reconstruction of a later snapshot of a volume given an earlier version of a volume and a differential block list relative to a later snapshot of the volume. The differential block list identifies the blocks to be retrieved or copied to update the earlier snapshot to reflect the content of the later snapshot.

A first feature hereof provides a method operable within a storage system for generating a differential block list. The method includes generating a first snapshot of a base volume wherein the first snapshot is maintained using copy-on-write operations of the base volume. The method then provides for performing as an atomic operation the following additional steps: generating a second snapshot of the base volume wherein the second snapshot is maintained using copy-on-write operations on the base volume; and generating an overwritten data list of data saved in the first snapshot by copy-on-write operations on the base volume. The method then concludes by generating a differential block list using the first snapshot and using the second snapshot and using the overwritten data list wherein the differential block list identifies differences between the first and second snapshots of the base volume.

Another feature hereof provides a storage system that includes a base volume stored on one or more storage devices of the storage system. The storage system also includes a controller coupled to the base volume and adapted to generate a plurality of snapshot copies of the base volume each corresponding to the content of the base volume at a corresponding point in time the controller further adapted to maintain each of the plurality of snapshot copies using copy-on-write operations when updating the base volume to generate an overwritten data list associated with each snapshot copy. The controller is further adapted to generate a differential block list using a first snapshot copy and using a second snapshot copy and using the overwritten data list associated with the second snapshot copy wherein the differential block list identifies differences between the first and second snapshot copies of the base volume.

### BRIEF DESCRIPTION OF THE DRAWINGS

FIG. 1 is a block diagram of an exemplary storage system enhanced in accordance with features and aspects hereof to permit differential backup processing by capabilities within the storage system devoid of attached host processing.

FIGS. 2-4 are flowcharts describing exemplary methods operable in a storage system such as that of FIG. 1 in accordance with features and aspects hereof to generate differential backup information within the storage system devoid of processing in any attached systems.

### DETAILED DESCRIPTION OF THE DRAWINGS

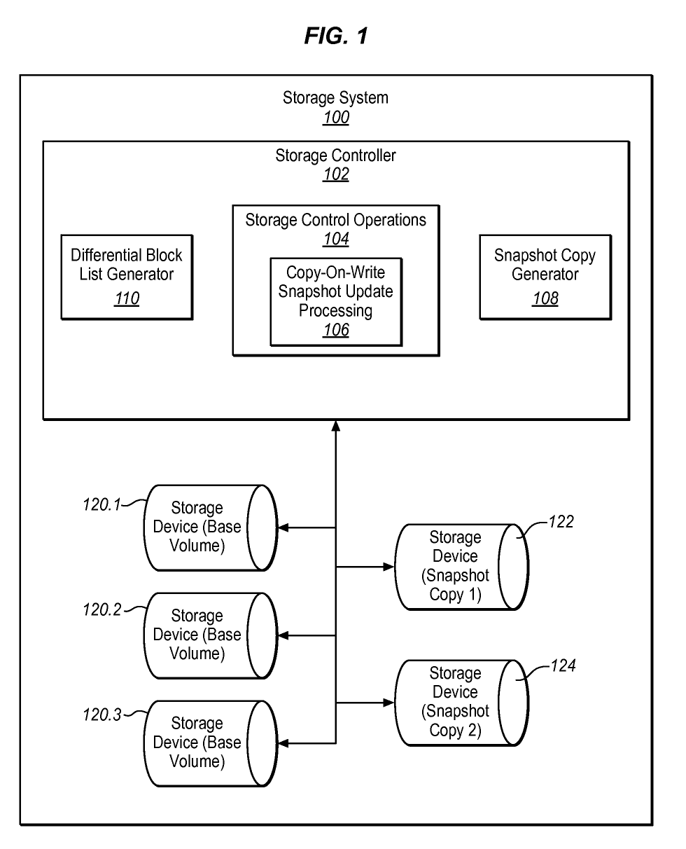

FIG. 1 is a block diagram of an exemplary storage system 100 embodying features and aspects hereof for rapid differential backup capabilities performed within the storage system 100. Storage system 100 may include storage controller 102 coupled to a plurality of storage devices 120.1, 120.2, 120.3, 122, and 124. Normal storage control operations element 104 operable within storage controller 102 logically subdivides the physical storage space of the various storage devices in one or more logical volumes. Each logical volume may be defined to comprise a portion or all of each of one or more of the storage devices within storage system 100. For example, as shown in FIG. 1, storage devices 120.1 through 120.3 are defined as a logical volume referred to herein as the “base volume” (e.g., the logical volume to which I/O and backup requests are directed by host systems). Those of ordinary skill in the art will readily recognize that any number of such storage devices may be present within a particular storage system 100. Further, any number of logical volumes but may be defined and distributed over the plurality of storage devices. The number of such storage devices and the definition of one or more logical volumes distributed over such storage devices are well known matters of design choice in accordance with needs of a particular storage application environment. Further, those of ordinary skill in the art will readily recognize that a variety of storage management techniques may be utilized for distributing a base volume over any portions of one or more storage devices. For example, various RAID storage management techniques may be applied to management of the base volume distributed over storage devices 120.1 through 120.3. RAID storage management may improve performance of the base volume (i.e., through striping techniques) and may enhance reliability (i.e., through redundancy techniques). Or, for example, simple striping devoid of additional redundancy may be utilized in distributing data over the storage devices that comprise base volume.

Snapshot copy generator 108 within storage controller 102 of storage system 100 generates a snapshot copy of the base volume distributed over storage devices 120.1 through 120.3. Such a snapshot copy may be stored on other storage devices or locations of storage system. For example, snapshot copy generator 108 may be requested to generate a first snapshot copy stored on storage device 122 and may later be requested to generate a second snapshot copy stored on storage device 124.

As is generally known in the art, generating a snapshot copy may be performed most efficiently by use of so-called copy-on-write techniques operable as an aspect of storage control operations 104. Thus a snapshot copy generated by snapshot copy generator 108 does not require actual physical copying of each data item of the base volume but rather maintains a list of information indicating whether any particular data item of the base volume has been changed since the snapshot copy was generated. In other words, any data item that is changed in the base volume by an I/O write operation is first copied to the snapshot storage area by operation of the copy-on-write snapshot update processing element 106 operable in conjunction with storage control operations 104. Using such copy-on-write operation management, any write request processed by storage control operations 104 directed at modifying data in the base volume will first copy the existing data (old data) to any current snapshot copies previously generated by snapshot copy generator 108. Thus, the original data in the base volume at the time of generation of the snapshot copy is retained within the storage device used to store the snapshot copy. Only those items of data so overwritten by standard storage control operations 104 will be so duplicated by copy-on-write snapshot of update processing element 106. Other data items in the base volume that are not overwritten need not be copied to the snapshot copy at time of creation of the snapshot. Rather, unmodified data items of the base volume may be copied at a later time as a background process or need not ever be copied unless the snapshot copy is intended to be archived as a full backup of the base volume. Thus, as well known in the art, initial creation of a snapshot copy is a rapid process and the base volume image at the time of the snapshot copy is maintained by the copy-on-write operations integrated within the standard storage control operations of the storage controller 102. Those of ordinary skill in the art further understand that copy-on-write operations by snapshot update processing 106 is operable to save old data from the base volume only upon the first attempt to overwrite the data since the time of the corresponding snapshot copy. Subsequent write operations processed by storage control operations 104 on the same previously overwritten data do not again copy data from the base volume to any current snapshot copies. Only the first such write operation to overwrite base volume data causes such a copy-on-write operation to update current snapshot copies.

Copy-on-write operations are well known to those of ordinary skill in the art such as, for example, Microsoft's Windows Server volume shadow copy service widely utilized in commerce. Such snapshot copies are frequently utilized in applications that require a static unchanging copy of contents of a volume to perform their intended functions. Thus a snapshot copy may be requested by an application, such as a volume backup application, the snapshot copy is established quickly and maintained by copy-on-write techniques so that further I/O operations may proceed while the backup application program utilizes the snapshot copy generated at commencement of the backup process.

As discussed generally above, differential backup is often preferred to full backup and incremental backup procedures in that the resources required to restore a backup data item are substantially less than that required for restoration of data from incremental backups. Further, differential backups (like incremental backups) utilize less storage space than required by full backup procedures. Both differential and incremental backup procedures tend to be somewhat faster than full backup procedures however differential backup procedures, as presently practiced in the art, still require substantial data processing capability to determine precisely what data has changed since a previous full backup procedure.

In accordance with features and aspects hereof, storage controller 102 of system 100 includes differential block list generator 110 adapted to rapidly determine data items required for a differential backup representing the difference between any two previously generated snapshot copies of a base volume. Thus, differential block list generator 110 within storage controller 102 is operable to utilize information in a first snapshot copy of the base volume, a second snapshot copy of a base volume, and other information representing data overwritten between the first and second snapshot copies. As discussed further herein below, snapshot copy generator 108 is operable in accordance with features and aspects hereof to simultaneously initiate a snapshot copy of a base volume at a particular designated time and also to generate an overwritten data list representing data items in an earlier snapshot copy that have been saved as overwritten since the time of that earlier snapshot. Such an overwritten data list may be stored in any useful storage medium associated with storage system 100. In one exemplary embodiment, one or more such overwritten data lists may be stored in the same storage media used for storage of a particular snapshot. For example, storage device 124 used for storing snapshot copy 2 of the base volume may also store an overwritten data list corresponding to data items overwritten within snapshot copy 1 on device 122 since the time of generation of that earlier first snapshot. In like manner, where more than two snapshot copies are generated (not shown in FIG. 1) each chronologically later snapshot may be stored along with the generated overwritten data list for each earlier snapshot copy of the same base volume. Thus, for example, a third snapshot copy (not shown in FIG. 1) may also retain an overwritten data list for earlier snapshot copy 2 and another overwritten data list for earlier snapshot 1 each list representing data items overwritten in those respective snapshot copies following generation of the third snapshot copy.

In addition, features and aspects hereof may utilize the generated differential block list to “roll forward” a volume from an earlier snapshot of the volume to match the content of a later or subsequent snapshot. Such a roll forward may be useful, for example, in replication or other distributed storage enterprises. A newer copy of a volume may be forwarded to another site that has an earlier snapshot copy of a volume by forwarding the updated blocks that changed since the time of the first snapshot when a second snapshot was created—i.e., those blocks identified in the appropriate differential block list. Such a compact representation then allows the other site to rapidly re-create the volume content corresponding to the second snapshot—as compared to the potentially lengthy process of communicating the entire second volume to the other site.

Additional exemplary details of methods associated with the enhanced storage system 100 of FIG. 1 are discussed further herein below. Those of ordinary skill in the art will readily recognize that any number of storage devices used to store any number of logical base volumes and/or snapshot copies may be provided in a storage system 100 in accordance with features and aspects hereof. Further, those of ordinary skill in the art will recognize numerous additional functional elements within a fully functional storage controller 102 and a fully functional storage system 100. Such well known additional elements are eliminated herein only for simplicity and brevity of this discussion. Still further, those of ordinary skill in the art will recognize a variety of additional features providing redundancy in high performance and/or high availability storage systems 100. For example, redundant storage devices, redundant communication paths between such storage devices and the storage controller, and even redundant storage controllers are often present in such high performance and/or high availability storage systems. Such well-known redundant features in a high performance, high reliability storage system are well known to those of ordinary skill in the art and are omitted in FIG. 1 for simplicity and brevity of this discussion.

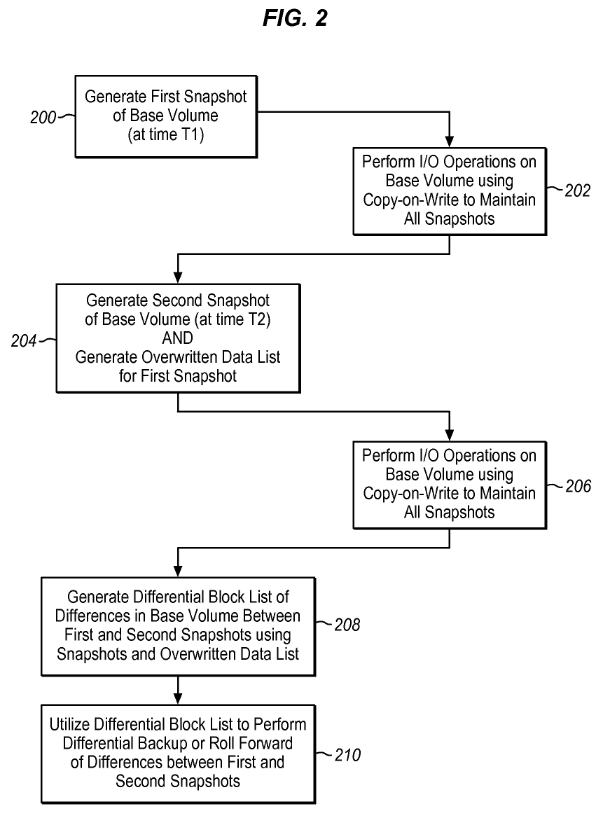

FIG. 2 is a flowchart describing an exemplary method in accordance with features and aspects hereof operable in a storage system such as that of FIG. 1 and adapted to generate a differential block list using a first and second snapshot generated within storage system. As noted above, a differential block list generator creates a list of data items representing differences between a first snapshot of a volume and a subsequent second snapshot of the same base volume. Such snapshot copies are rapidly generated within a storage system as a list of data items that have been overwritten in the base volume since the time of the generation of the corresponding snapshot. Well-known copy-on-write operations within the storage controller of the storage system are adapted to generate and maintain such an overwritten data list representing saved copies of data from the base volume. The saved copies of data overwritten in the base volume therefore represent the previous state of the base volume prior to the overwriting or in other words the state of the base volume at the time of generation of the corresponding snapshot. Such snapshot volume copy operations and corresponding copy-on-write operations to generate and maintain an overwritten data list representing the snapshot copy over time are well known to those of ordinary skill in the art.

The method of a FIG. 2 generally utilizes a first snapshot copy and a second snapshot copy both maintained by the same copy-on-write operations on the base volume. The method of FIG. 2 also generally utilizes a copy of the overwritten data list of the earlier first snapshot captured as an atomic operation during generation of the second snapshot copy of the base volume.

Element 200 of FIG. 2 represents processing responsive to a request to generate a first snapshot copy of the base volume. The time at which the first snapshot copy is generated will be referred to herein as “T1”. As is generally known in the art, during the period of time that the storage system is generating the first snapshot, I/O operations are temporarily deferred to permit the first snapshot to be generated as a consistent version of the base volume. Generation of such a snapshot copy is generally known in the art as typified by Microsoft Windows Server volume shadow copy services and other well-known commercially available snapshot copy tools and applications. Further, generation of such snapshot copies is known to be performed either by host attached application or systems software as well as by independent operation of a storage system through its storage controller. LSI Logic and other storage related vendors provide numerous products capable of performing such snapshot copy operations by processing within the storage system.

Once the first snapshot copy generation is completed, element 202 represents continued operation to perform normal I/O requests on the base volume utilizing copy-on-write operations to maintain all presently known snapshots (e.g., the first snapshot generated by operation of element 200 any others previously generated). As noted above and as generally known in the art, copy-on-write operations assure that the stored data of the base volume corresponding to the snapshot at time T1 will be maintained in the storage space scavenging the first snapshot despite the overwriting of the corresponding data by processing of normal I/O operations on the base volume. In other words, as well known in the art, copy-on-write operations assure that old data in the base volume is first copied to any related, currently known snapshots before overwriting the data in the base volume in response to the received I/O request.

Element 204 then represents processing responsive to a user or application request to generate a second snapshot copy of the base volume. This second snapshot is generated at a subsequent time referred to herein as T2. Substantially concurrent with the generation of the second snapshot copy (e.g. as an atomic operation therewith) processing of FIG. 2 also generates a copy of the overwritten data list for the earlier first snapshot. This copy of the overwritten data list for the first snapshot may preferably be stored with the information representing the second snapshot or may be stored in any other suitable memory component of the storage system in association with the generated second snapshot copy. Those of ordinary skill in the art will recognize that the “atomicity” referred to herein refers to the fact that the base volume first snapshot and second snapshot are essentially frozen until completion of both elements of the atomic processing—namely until completion of both the generation of the second snapshot copy and the generation of a copy of the overwritten data list for the first snapshot at the time of generation of the second snapshot copy. Thus the two operations may be substantially concurrent or may be performed in any sequential so long as no revisions are made to the base volume, the first snapshot, or second snapshot until the second snapshot is completed and the copying of the overwritten data list of the first snapshot is also completed.

Following generation of the second snapshot, element 206 represents continued performance of I/O operations responsive to receipt of I/O requests directed to the base volume. The processing of element 206 further includes copy-on-write operations to maintain all currently active snapshots (e.g., the first snapshot copy and the second snapshot copy generated by processing of elements 200 and 204, respectively).

Element 208 represents further processing responsive to a user or application program request to generate a differential block list. The differential block list represents a list of data items that are different in the base volume as represented at the first snapshot copy and that of the base volume as represented at the second snapshot (e.g., the base volume contents at time T1 versus the updated base volume contents at time T2). The differential block list is generated by element 208 utilizing information in the first and second snapshots as well as the copy of the overwritten data list of the first snapshot captured by the atomic operation of element 204. More specifically, element 204 represents processing to select data items to add to the differential block list selected either from the current base volume data or from the second snapshot information. The selection is based on information in the overwritten data list and the first and second snapshot information.

Having generated such a differential block list, element 210 represents any appropriate processing to utilize the differential block list, for example, to generate a differential backup of differences between the first and second snapshots of the base volume. As noted above, a differential backup may be a preferable form of backup in many application environments in that it is a compact representation of a backup and requires no intervening incremental backups as may be required in an incremental backup procedure. Rather, the differential backup generated using the differential block list requires only the initial base volume snapshot from which the differential block list is computed to fully restore a volume to the status represented by the second snapshot used to generate the differential block list. Further, the differential block list may also be used for a roll forward operation to permit a site/node to rapidly construct a newer version of a volume corresponding to a later (e.g., second) snapshot using the volume content corresponding to an earlier (e.g., first) snapshot and changed blocks identified in the differential block list.

More specifically, element 210 represents processing to generate an actual differential backup set of data stored in a storage medium to permit reliable restoration of the base volume to the earlier status represented by the second snapshot. Thus the differential block list identifies data items to be retrieved and copied for persistent storage as a differential backup of the base volume relative to its status at the time of the first snapshot. The retrieved data items may be stored on a storage device within the storage system (e.g., separate and distinct from the storage devices used for the base volume storage) or may be stored on a remote device accessible through network or other interface communication channels and protocols. Thus, element 210 represents any suitable processing as a matter of design choice appropriate for a particular application to actually generate the differential backup represented by the list of data items generated by operation of elements 200, 204, and 208.

Still further, element 210 may also represent utilization of the differential block list to generate volume contents corresponding to a later (e.g., second) snapshot of a volume given the content of an earlier (e.g., first) snapshot of the volume and the differential block list.

Those of ordinary skill in the art will readily recognize that FIG. 2 is intended merely as exemplary of one possible embodiment of a method in accordance with features and aspects hereof. Numerous additional steps may be provided in a fully operational method to generate and utilize a differential block list by processing within the storage system. In addition, those of ordinary skill in the art will recognize that elements 202 and 206 are described merely as a representative of continuing normal operation of the storage subsystem rather than expressing features and aspects of methods hereof. In other words, elements 202 and 206 a FIG. 2 are intended as normal processing within a storage subsystem capable of utilizing copy-on-write operations to perform received I/O write requests in the presence of previously generated snapshot copies of the base volume. By contrast, elements 200, 204, and 208 are intended as representative of an exemplary method in accordance with features and aspects hereof.

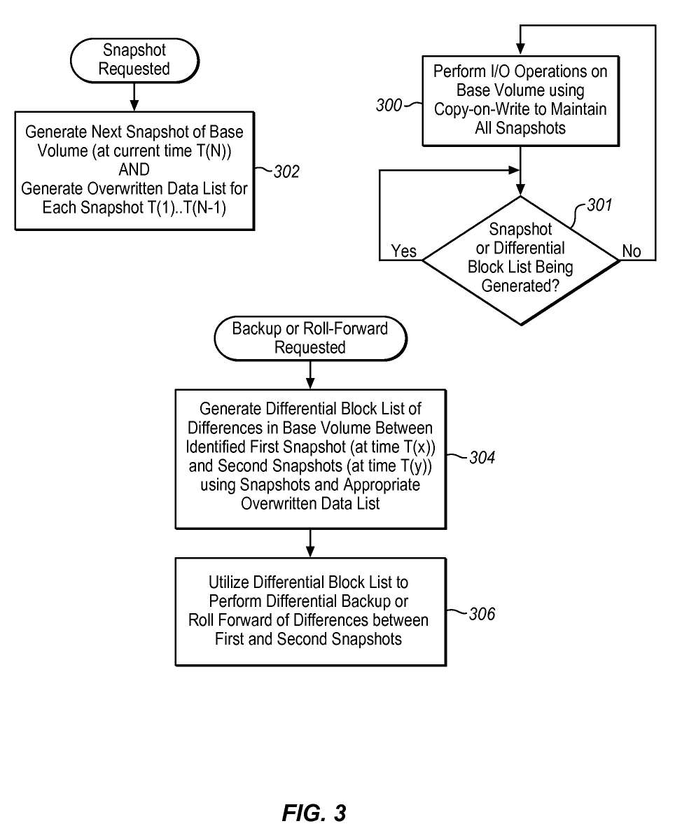

FIG. 3 is a collection of related flowcharts expressing another exemplary embodiment of features and aspects hereof to generate a differential block list from any two snapshot copies of a base volume in conjunction with a copy of a overwritten data list corresponding to the earlier of the two snapshot copies at the time of generation of the second or later snapshot copy. Element 300 of FIG. 3 represents continuous normal processing within storage system to process I/O requests utilizing copy-on-write techniques to maintain the integrity of any previously generated snapshot copies of the base volume. Following processing of one or more received I/O requests by operation of element 300 utilizing copy-on-write operations, element 301 is next operable to determine whether generation of a snapshot (e.g., a differential block list) has been requested and is being generated. If not, processing continues looping back to element 300 to continue processing further I/O requests utilizing copy-on-write operations. If generation of a snapshot has been requested or is still in process of being generated, element 301 continues to loop until the snapshot generation has been completed. In other words, elements 300 and 301 represent continuous normal processing of I/O requests utilizing copy-on-write operations until such time as a snapshot copy is requested.

Element 302 represents processing responsive to an asynchronous request received to generate a new snapshot at the current point in time. Any of several managerial and administrative factors may be considered by a user or administrative system to determine when a snapshot should be generated. For example, a snapshot may be requested periodically through a day or any period of time. Or, for example, a snapshot copy may be requested as part of the startup of a backup application program or a replication (e.g., roll forward requester) program on an attached host system. Such a backup or roll forward application (compatible with a storage system in accordance with features and aspects hereof) would likely request that the storage system generate a snapshot copy at the start of the application so that other I/O requests may proceed during the processing of the backup or replication related application. Element 302 represents the processing to generate a next snapshot of the base volume at the current time T(N). In addition, as an atomic operation substantially concurrent with generation of the next snapshot, element 302 also generates a copy of the overwritten data list for all earlier snapshots of the same base volume presently known to the system (e.g., snapshots generated at times T(1) through T(N−1)). As noted above, the generation of the next snapshot and the generation of the copy of the previous snapshots overwritten data lists are performed substantially concurrently or may be generated sequentially. In all cases the snapshot generation and the copying of the overwritten data list of earlier snapshots are completed before other processing of requests on the base volume resumes.

Those of ordinary skill in the art will readily recognize that a storage system may choose to maintain any number of such snapshot copies in accordance with well known design choices for the particular application. Generation of a next snapshot may therefore further entail removing some previous older snapshot such that only a fixed number of most recent snapshots need be maintained by the storage system. These and other design choices related to generation and maintenance of snapshot copies are readily apparent to those of ordinary skill in the art.

Elements 304 and 306 represent processing responsive to a request from a user or administrative application to generate a differential block list and a corresponding differential backup or roll forward data set by using a first identified snapshot copy, a second identified snapshot copy, and the appropriate copied overwritten data list (e.g., the overwritten data list of the first snapshot corresponding to the time of generation of the second snapshot). The backup or roll forward data set is the actual data blocks identified in the differential block list required to recreate the desired backup or roll forward volume contents. Thus, the requested differential block list is created from a supplied first snapshot corresponding to the state of the base volume at time T(x), a supplied second snapshot corresponding to the state of the base volume at time T(y), and a supplied copy of the overwritten data list corresponding to the snapshot at time T(x) generated at time T(y). As noted, the identified overwritten data list may be stored or associated with the corresponding second snapshot. As noted above, the differential block list is generated generally by element 304 for each data item identified in the associated overwritten data list, selecting either a data item saved in the second snapshot or the current content of the same data item from the base volume. Further exemplary details of the generation of the differential block list are provided herein below.

Following generation of the differential block list, element 306 represents any useful processing to utilize the generated differential block list to perform a desired differential backup or roll forward of differences in the base volume as represented at the first snapshot and at the subsequent second snapshot. Element 306 of FIG. 3 is operable to perform processing similar to that of element 210 discussed above with respect to FIG. 2. In particular, element 306 represents any suitable processing appropriate for the particular storage application to generate the actual differential backup data set or roll forward data set represented by the data items identified in the differential block list. The differential backup or roll forward data so generated may be stored on another storage device within the storage system (e.g., a backup storage device physically separate and distinct from the storage devices comprising the base volume) or may be stored remotely communicated via networking or other peripheral interface communication media and protocols to a remote storage system, remote storage device, or remote computing system. Those of ordinary skill in the art will recognize a wide variety of design choices useful for generating and persistently storing the actual differential backup data set indicated in the differential block list.

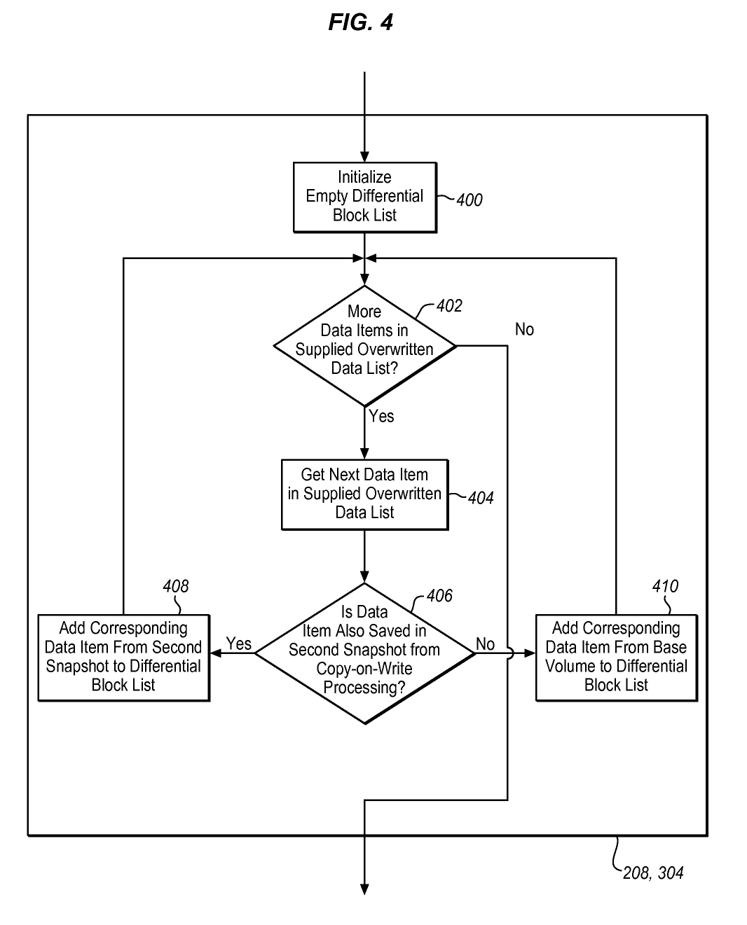

FIG. 4 is a flowchart providing exemplary additional details of the processing of either element 208 of FIG. 2 or element 304 of FIG. 3 to generate a differential block list from: a supplied first snapshot copy, a supplied second snapshot copy, and a saved overwritten data list corresponding to the overwritten data recorded in the first snapshot at the time of generating the second snapshot. As noted above, elements 208 and 304 are generally operable to select a data item for differential backup or roll forward purposes for each data item identified in the saved copy of the overwritten data list captured from the first snapshot at the time of generation of the second snapshot. The corresponding data item is selected either from the current base volume or from the second snapshot based on comparison logic discussed further herein below.

Element 400 is first operable to generate an initially empty differential block list (i.e., empty of any entries representing data items to be backed up in a differential backup procedure). Elements 402 through 410 are then repetitively operable for each data item identified in the supplied overwritten data list captured as part of the atomic operation concurrent with generation of the supplied second snapshot. As each data item identified in the supplied overwritten data list is analyzed, a corresponding data item, either from the current content of the base volume or from the saved content in the second snapshot, is selected and added to the differential block list.

Element 402 is therefore first operable to determine whether additional data items remain to be analyzed in the supplied overwritten data list. If not, processing of element 208 or 304 is completed. Otherwise, element 404 is operable to retrieve the next data item from the supplied overwritten data list. Element 406 then determines whether the next identified data item retrieved from the supplied overwritten data list is presently saved in the supplied second snapshot copy as updated by the ongoing copy-on-write operations. In other words, if the corresponding data item has been overwritten in the base volume after the time of generation of the second snapshot copy, then the old data saved in the second snapshot copy by copy-on-write operations is used for the differential block list. Otherwise, the present data content of the corresponding data item in the base volume is used for the differential block list. Thus, if element 406 determines that the next item in the supplied overwritten data list is presently saved in the second snapshot copy, element 408 is operable to add the corresponding data item from the second snapshot to the differential block list. Otherwise, element 410 is operable to add the corresponding data item from the base volume to the differential block list.

As has been discussed herein above, the snapshot copy, associated copy-on-write operations, and the overwritten data list are referred to in terms of data items or lists of data items. Those of ordinary skill in the art will readily recognize that the data item so referred to may include individual physical and/or logical blocks of the base volume (or snapshot copies of lists), may include aggregated clusters of related or contiguous blocks, may include a plurality of related blocks formed as a RAID stripe, or may refer to any other logical or physical grouping of multiple blocks. In one common embodiment where RAID management is used on operations in the base volume, the data items referred to in the various snapshot copies, in the base volume, in the overwritten data list, and in the generated differential block list may all refer identified stripes overwritten during write operations employing copy-on-write techniques in the baseline. The particular size/granularity of the data item may be selected as a well-known matter of design choice appropriate to the particular storage application.

The following tables provide examples of processing associated with features and aspects hereof to generate a differential block list from a first snapshot copy and an overwritten data list as discussed above. In particular, the tables presented below exemplify the use of snapshot copies to generate differential block lists in accordance with the features, aspects, methods and structures presented herein above.

Presume a base volume comprises 9 blocks of data (noting as above that a “block” may also more broadly be any data item such as a single physical or logical block, a stripe of related blocks, a cluster of related blocks, etc.). The base volume may be represented by the following table:

Base Volume

| Block | Last Update |
|---|---|
| B1 | 0.80 |
| B2 | 0.82 |
| B3 | 0.84 |
| B4 | 0.86 |
| B5 | 0.88 |
| B6 | 0.90 |
| B7 | 0.92 |
| B8 | 0.94 |
| B9 | 0.96 |

The “Last Update” column indicates a time of the last update to write the corresponding block (no particular unit of time is intended by the exemplary values—any useful time base may be presumed for this example).

A first snapshot copy is requested at time “1.0”. Such a first snapshot may be represented by the following table:

Snapshot Copy 1

| Block | Last Update |
|---|---|
| B1 | Unchanged Base |
| B2 | Unchanged Base |
| B3 | Unchanged Base |
| B4 | Unchanged Base |
| B5 | Unchanged Base |
| B6 | Unchanged Base |
| B7 | Unchanged Base |
| B8 | Unchanged Base |
| B9 | Unchanged Base |

The last update column of such a snapshot logically indicates “Unchanged Base” meaning that the content of the corresponding block is unchanged relative the content of the base volume at the time the snapshot copy was created. Thus there is no storage space required initially to generate a snapshot copy of the base volume—all blocks of the snapshot are the same as the current content of the base volume. Only when changes are made to the base volume will the copy-on-write operations update this status to save an old copy of the original data in the base volume at the time of the generation of snapshot copy 1.

As the first snapshot generated, there is no earlier snapshot from which to save a copy of the overwritten data list (i.e., the overwritten data list is empty for snapshot copy 1). At a later time (2.0), another snapshot is requested (e.g., by an application that requires a static copy of the volume for its intended purpose). Presume that blocks B5 . . . B9 have been overwritten at various times between time 1.0 and time 2.0. The base volume, snapshot copy 1, and snapshot copy 2 may be represented by the following tables:

| Base Volume | | Snapshot Copy 1 | | Snapshot Copy 2 | |
|---|---|---|---|---|---|
| Block | Last Update | Block | Last Update | Block | Last Update |
| B1 | 0.80 | B1 | Unchanged Base | B1 | Unchanged Base |
| B2 | 0.82 | B2 | Unchanged Base | B2 | Unchanged Base |
| B3 | 0.84 | B3 | Unchanged Base | B3 | Unchanged Base |
| B4 | 0.86 | B4 | Unchanged Base | B4 | Unchanged Base |
| B5 | 1.20 | B5 | 0.88 | B5 | Unchanged Base |
| B6 | 1.25 | B6 | 0.90 | B6 | Unchanged Base |
| B7 | 1.30 | B7 | 0.92 | B7 | Unchanged Base |
| B8 | 1.35 | B8 | 0.94 | B8 | Unchanged Base |
| B9 | 1.40 | B9 | 0.96 | B9 | Unchanged Base |

Copy-on-write operations changing the content of the base volume between time 1.0 and time 2.0 assured that snapshot copy 1 has saved the old data of blocks B5 . . . B9 from the time of the generation of snapshot copy 1. The overwritten data list of snapshot copy 1 (comprising blocks B5 . . . B9) is also copied and saved in association with the storage of snapshot copy 2. As noted above, the initial generation of the snapshot copy 2 and the copying of the overwritten data list of snapshot copy 1 at that time is an atomic operation such that no changes may occur in the snapshots or in the base volume until the snapshot generation and copying of the list is completed.

A differential block list may be generated using the two snapshots and the copied overwritten data list. In this simple case, the differential block list may be represented as the following table:

1–2 DIFF Time 2.0

| Block | | Loc |
|---|---|---|
| B1 | | |
| B2 | | |
| B3 | | |
| B4 | | |
| B5 | 1.20 | Base |
| B6 | 1.25 | Base |
| B7 | 1.30 | Base |
| B8 | 1.35 | Base |
| B9 | 1.40 | Base |

The difference between snapshot copy 2 and the earlier snapshot copy 1 are in the data of blocks B5 . . . B9. The correct data for blocks B5 . . . B9 at the time of snapshot copy 2 is represented as the data in blocks B5 . . . B9 in the base volume (as indicated in the “Loc” column of the table. Thus a differential backup process may use this list to copy the content of blocks B5 . . . B9 from the base volume to generate a differential backup of the volume corresponding to time 2.0.

The following tables reflect the base volume at time 3.0—the time of a next requested snapshot copy 3.

| Base Volume | | Snapshot Copy 1 | | Snapshot Copy 2 | | Snapshot Copy 3 | |
|---|---|---|---|---|---|---|---|
| Block | Last Update | Block | Last Update | Block | Last Update | Block | Last Update |
| B1 | 0.80 | B1 | Unchanged Base | B1 | Unchanged Base | B1 | Unchanged Base |
| B2 | 0.82 | B2 | Unchanged Base | B2 | Unchanged Base | B2 | Unchanged Base |
| B3 | 0.84 | B3 | Unchanged Base | B3 | Unchanged Base | B3 | Unchanged Base |
| B4 | 2.10 | B4 | 0.86 | B4 | 0.86 | B4 | Unchanged Base |
| B5 | 1.20 | B5 | 0.88 | B5 | Unchanged Base | B5 | Unchanged Base |
| B6 | 1.25 | B6 | 0.90 | B6 | Unchanged Base | B6 | Unchanged Base |
| B7 | 2.10 | B7 | 0.92 | B7 | 1.30 | B7 | Unchanged Base |
| B8 | 2.20 | B8 | 0.94 | B8 | 1.35 | B8 | Unchanged Base |
| B9 | 2.30 | B9 | 0.96 | B9 | 1.40 | B9 | Unchanged Base |

As above, the new snapshot copy 3 indicates that all data is unchanged from the base volume at time 3.0. As can be seen in the exemplary tables representing time 3.0, block B4 has also been changed so that the copy-on-write has saved the old content last updated prior to time 1.0 to save the old content in both snapshot copy 1 and snapshot copy 2. In addition, blocks B7 . . . B9 were updated after time 2.0 and hence the copy-on-write operations saved old content of those blocks in snapshot copy 2 (though not in snapshot copy 1 because they were already saved there by an earlier copy-on-write operation). The overwritten data list for both snapshot copy 1 and snapshot copy 2 at time 3.0 are copied and saved with snapshot copy 3. In particular, the overwritten data list for snapshot copy 1 at time 3.0 includes blocks B4 . . . B9. The copied overwritten data list for snapshot copy 2 at time 3.0 includes blocks B4 and B7 . . . B9.

Using snapshot copy 3, snapshot copy 1 and the copied overwritten data list of snapshot copy 1 saved at time 3.0 with snapshot copy 3, a differential block list may be generated and represented by the following table:

1–3 DIFF Time 3.0

| Block | | Loc |
|---|---|---|
| B1 | | |
| B2 | | |
| B3 | | |
| B4 | 2.10 | Base |
| B5 | 1.20 | Base |
| B6 | 1.25 | Base |
| B7 | 2.10 | Base |
| B8 | 2.20 | Base |
| B9 | 2.30 | Base |

In this differential block list, blocks B4 . . . B9 are to be retrieved from the base volume to represent the difference in the content of the base volume between time 1.0 and time 3.0. In like manner, a differential block list may also be generated to represent the difference in base volume content from time 1.0 to time 2.0 but now at time 3.0 (using snapshot copy 2 as updated, snapshot copy 1 as updated, and saved overwritten data list for snapshot copy 2 at time 2.0). That differential block list presents the same list of blocks as the above table “1-2 DIFF Time 2.0” but identifies the block as located in different locations due to the update of the base volume following time 2.0. This differential block list may be represented by the following table:

1–2 DIFF Time 3.0

| Block | | Loc |
|---|---|---|
| B1 | | |
| B2 | | |
| B3 | | |
| B4 | | |
| B5 | 1.20 | Base |
| B6 | 1.25 | Base |
| B7 | 1.30 | Snap2 |
| B8 | 1.35 | Snap2 |
| B9 | 1.40 | Snap2 |

Blocks B5 . . . B6 are still retrieved from the base volume but blocks B7 . . . B9 are now retrieved from snapshot copy 2 since the base volume was updated after time 2.0 relative to these blocks.

Carrying the examples forward to a time 4.0, a new snapshot copy 4 is generated (as above initially represented as the current unchanged base volume data). Presuming still further updates in the base volume between times 3.0 and 4.0, the exemplary base volume content and snapshot copies may be represented by the following tables:

| Base Volume | | Snapshot Copy 1 | | Snapshot Copy 2 | |
|---|---|---|---|---|---|
| Block | Last Update | Block | Last Update | Block | Last Update |
| B1 | 0.80 | B1 | Unchanged Base | B1 | Unchanged Base |
| B2 | 0.82 | B2 | Unchanged Base | B2 | Unchanged Base |
| B3 | 3.10 | B3 | 0.84 | B3 | 0.84 |
| B4 | 3.20 | B4 | 0.86 | B4 | 0.86 |
| B5 | 1.20 | B5 | 0.88 | B5 | Unchanged Base |
| B6 | 3.10 | B6 | 0.90 | B6 | 1.25 |
| B7 | 3.10 | B7 | 0.92 | B7 | 1.30 |
| B8 | 2.20 | B8 | 0.94 | B8 | 1.35 |
| B9 | 2.30 | B9 | 0.96 | B9 | 1.40 |

| | |
|---|---|
| Snapshot Copy 3 | Snapshot Copy 4 |

| Block | Last Update | Block | Last Update |
|---|---|---|---|
| B1 | Unchanged Base | B1 | Unchanged Base |
| B2 | Unchanged Base | B2 | Unchanged Base |
| B3 | 0.84 | B3 | Unchanged Base |
| B4 | 2.10 | B4 | Unchanged Base |
| B5 | Unchanged Base | B5 | Unchanged Base |
| B6 | 1.25 | B6 | Unchanged Base |
| B7 | 2.10 | B7 | Unchanged Base |
| B8 | Unchanged Base | B8 | Unchanged Base |
| B9 | Unchanged Base | B9 | Unchanged Base |

As above, the overwritten data list of snapshot copies 1, 2, and 3 are saved along with snapshot copy 4. In particular, the overwritten data list for snapshot 1 at time 4.0 indicates blocks B3 . . . B9, for snapshot 2 indicates B3, B4, and B6 . . . B9, for snapshot 3 indicates blocks B3, B4, B6, and B7.

A differential block list may then be generated representing the differences between the base volume at time 1.0 and the base volume at time 4.0. That list indicates that all changed blocks B3 . . . B9 are presently represented by the data in the base volume and the list may be represented by the following table:

1–4 DIFF Time 4.0

| Block | | Loc |
|---|---|---|
| B1 | | |
| B2 | | |
| B3 | 3.10 | Base |
| B4 | 3.20 | Base |
| B5 | 1.20 | Base |
| B6 | 3.10 | Base |
| B7 | 3.10 | Base |
| B8 | 2.20 | Base |
| B9 | 2.30 | Base |

Further, differential block lists may also be generated for the differences from time 1.0 to time 3.0 and may be represented by the following table:

1–3 DIFF Time 4.0

| Block | | Loc |
|---|---|---|
| B1 | | |
| B2 | | |
| B3 | | |
| B4 | 2.10 | Snap3 |
| B5 | 1.20 | Base |
| B6 | 1.25 | Snap3 |
| B7 | 2.10 | Snap3 |
| B8 | 2.20 | Base |
| B9 | 2.30 | Base |

Though the list represents the same data content for changed blocks B4 . . . B9, the locations of the blocks used for the differential backup are changed relative to the above table “1-3 DIFF Time 3.0”. In particular, blocks B4, B6, and B7 are retrieved from the snapshot copy 3 rather than the base volume because another copy-on-write operation changed those blocks in the base volume between times 3.0 and 4.0 (and saved the earlier data in snapshot copy 3).

In like manner the differential block list for time 2.0 relative to time 1.0 may also be generated at time 4.0. As expected, the blocks identified are the same as those identified in the table “1-2 DIFF Time 2.0” and “1-2 DIFF Time 3.0” but the blocks are identified as stored in a different location.

Those of ordinary skill in the art will readily recognize further extensions of the methods and structures hereof to generate still later snapshot copies and the use the information so captured to generate any desired differential block list. Further, those skilled in the art will also recognize that any number of blocks, representing any level of granularity, may be used in a base volume and the snapshot copies generated in accordance with features and aspects hereof. The exemplary tables above are therefore merely intended to exemplify processing in accordance with features and aspects hereof to maintain the required differences through multiple snapshot copies to permit generation of any desired differential block list.

Further, those of ordinary skill in the art will recognize that the above tabular examples are expressed as applied to perform a differential backup procedure. Similar procedures may be employed to generate a differential block list useful for roll forward operations such as in data replication applications. In such a roll forward, the differential block list identifies blocks that have been updated in the later snapshot relative to the content of an earlier snapshot. Thus a recipient of the differential block list in possession of the contents of the volume corresponding to the earlier snapshot may easily update (i.e., roll forward) the volume content to match that of the later (e.g., second) snapshot. In general the recipient of the differential block list may retrieve the blocks identified in the differential block list to update the earlier volume contents corresponding to the first snapshot. Alternatively the identified blocks may be retrieved by the transmitter of information and the actual affected blocks' contents sent to the recipient. Details of such an operation will be evident to those of ordinary skill in the art in view of the exemplary descriptions above expressed in terms of differential backup processing.

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. In particular, those of ordinary skill in the art will readily recognize that features and aspects hereof may be implemented equivalently in electronic circuits or as suitably programmed instructions of a general or special purpose processor. Such equivalency of circuit and programming designs is well known to those skilled in the art as a matter of design choice. As a result, the invention is not limited to the specific examples and illustrations discussed above, but only by the following claims and their equivalents.

What is claimed is:

1. A method operable within a storage system for generating a differential block list, the method comprising:
generating a first snapshot of a base volume wherein the first snapshot is maintained using copy-on-write operations of the base volume;
as an atomic operation, performing the steps of:
generating a second snapshot of the base volume wherein the second snapshot is maintained using copy-on-write operations on the base volume; and
generating an overwritten data list of data saved in the first snapshot by copy-on-write operations on the base volume; and
generating a differential block list using the first snapshot and using the second snapshot and using the overwritten data list wherein the differential block list identifies differences between the first and second snapshots of the base volume.

2. The method of claim 1
wherein the step of generating a differential block list further comprises:
selecting data items to add to the differential block list from either the base volume or from the second snapshot based on information in the overwritten data list.

3. The method of claim 1
wherein the step of generating a differential block list further comprises:
for each data item in the overwritten data list that has not been overwritten since the creation of the second snapshot, adding the corresponding data item from the base volume to the differential block list; and
for each data item in the overwritten data list that has been overwritten since the creation of the second snapshot, adding the corresponding data item saved in the second snapshot to the differential block list.

4. The method of claim 1
wherein the step of generating a differential block list further comprises:
for each data item in the overwritten data list that has not been overwritten since the creation of the second snapshot, adding the corresponding data item from the base volume to the differential block list; and
for each data item in the overwritten data list that has been overwritten since the creation of the second snapshot, adding the corresponding data item saved in the second snapshot to the differential block list.

5. The method of claim 1
wherein the data items in the overwritten data list and in the differential block list each identify clusters of multiple blocks.

6. The method of claim 1
wherein the data items in the overwritten data list and in the differential block list each identify stripes of multiple blocks.

7. The method of claim 1 further comprising:
performing a differential backup of the data identified in the differential block list by copying the contents of data identified in the differential block list to a backup location.

8. The method of claim 7
wherein the step of performing a differential backup further comprises:
copying the contents of data identified in the differential block list to a backup storage device.

9. The method of claim 7
wherein the step of performing a differential backup further comprises:
copying the contents of data identified in the differential block list to a remote device over a network connection.

10. The method of claim 1 further comprising:
performing a roll forward of the data identified in the differential block list by copying the contents of data identified in the differential block list to another volume corresponding to the content of the first snapshot.

11. A storage system comprising:
a base volume stored on one or more storage devices of the storage system; and
a controller coupled to the base volume and adapted to generate a plurality of snapshot copies of the base volume each corresponding to the content of the base volume at a corresponding point in time the controller further adapted to maintain each of the plurality of snapshot copies using copy-on-write operations when updating the base volume to generate an overwritten data list associated with each snapshot copy,
wherein the controller is further adapted to generate a differential block list using a first snapshot copy and using a second snapshot copy and using the overwritten data list associated with the second snapshot copy wherein the differential block list identifies differences between the first and second snapshot copies of the base volume.

12. The system of claim 11
wherein the controller is further adapted to generate the differential block list by selecting data to add to the differential block list from either the base volume or from the second snapshot based on information in the overwritten data list.

13. The system of claim 11
wherein the controller is further adapted to generate the differential block list by performing steps of:
for each item in the overwritten data list that has not been overwritten since the creation of the second snapshot, adding the corresponding data item from the base volume to the differential block list; and
for each item in the overwritten data list that has been overwritten since the creation of the second snapshot, adding the corresponding data item saved in the second snapshot to the differential block list.

14. The system of claim 11
wherein the controller is further adapted to generate the differential block list by performing the steps of:
for each data item in the overwritten data list that has not been overwritten since the creation of the second snapshot, adding the corresponding data item from the base volume to the differential block list; and
for each data item in the overwritten data list that has been overwritten since the creation of the second snapshot, adding the corresponding data item saved in the second snapshot to the differential block list.

15. The system of claim 11 further comprising:
means for performing a differential backup of the data identified in the differential block list by copying the contents of data identified in the differential block list to a backup location.

16. The system of claim 11 further comprising:
means for performing a roll forward of the data identified in the differential block list by copying the contents of data identified in the differential block list to another volume corresponding to the content of the first snapshot.
